(19) United States
(12) Patent Application Publication
(10) Pub. No.: US 2025/0062057 A1
(43) Pub. Date: Feb. 20, 2025

(54) VARIABLE DAMPING IN COMPOSITE MATERIAL

(71) Applicant: RTX Corporation, Farmington, CT (US)

(72) Inventor: Eli Warren, Bend, OR (US)

(21) Appl. No.: 18/937,866

(22) Filed: Nov. 5, 2024

Related U.S. Application Data
(63) Continuation-in-part of application No. 18/743,509, filed on Jun. 14, 2024.
(60) Provisional application No. 63/529,547, filed on Jul. 28, 2023.

(51) Int. Cl. H01B 17/60; B33Y 40/20; B33Y 80/00; H01B 19/00

(52) U.S. Cl. CPC H01B 17/60; B33Y 40/20; B33Y 80/00; H01B 19/00

(57) ABSTRACT

A three-dimensional (3-D) composite structure includes a 3-D lattice structure having a plurality of electrically insulative struts, a matrix phase surrounding the 3-D lattice structure, first and second electrically conductive face sheets positioned on two faces of the 3-D lattice structure, and a plurality of electrically insulative containment sheets positioned on all faces of the 3-D lattice structure that do not include the first and second face sheets. The matrix phase includes an electrorheological material. The first and second face sheets are positioned such that an electric potential applied between the first and second face sheets creates an electric field in the matrix phase that causes a desired reversible alteration to the viscosity of the matrix phase. The first and second face sheets and the plurality of containment sheets are collectively configured to contain the matrix phase within the 3-D lattice structure.

### CROSS-REFERENCE TO RELATED APPLICATION

This application is a continuation-in-part of U.S. patent application Ser. No. 18/743,509 filed on Jun. 14, 2024, which claims priority from U.S. Patent Application 63/529,547 filed on Jul. 28, 2023, the subject matter of which are both incorporated into this application by reference in their entireties.

### BACKGROUND

The present disclosure relates generally to composite structures and, more particularly, to three-dimensional (3-D) lattice reinforced composite structures.

Aircraft structures, such as engine and fuselage structures, face multiple challenges such as retaining sufficient stiffness to function effectively as structural components while addressing the three dimensional stresses that result from the aircraft maneuvering while in flight. Additionally, it is desirable for such structures to be light weight for fuel efficiency and payload capability.

In some applications, such structures can made from metallic or polymeric foam cores sandwiched between thin sheets of facing materials to form load bearing structures that may include aerodynamic surfaces. In some applications, the foam cores can be replaced by certain repeating 3-D lattice structures, which can be made from metallic or polymeric materials. Given the continued focus on identifying more effective materials for aerospace and other high performance applications, it is desirable to identify further materials that can demonstrate the desired combination of light weight, high stiffness, strength, and toughness.

### SUMMARY

One aspect of the invention includes a three-dimensional (3-D) composite structure that includes a 3-D lattice structure having a plurality of electrically insulative struts, a matrix phase surrounding the 3-D lattice structure, first and second electrically conductive face sheets positioned on two faces of the 3-D lattice structure, and a plurality of electrically insulative containment sheets positioned on all faces of the 3-D lattice structure that do not include the first and second face sheets. The matrix phase includes an electrorheological material. The first and second face sheets are positioned such that an electric potential applied between the first and second face sheets creates an electric field in the matrix phase that causes a desired reversible alteration to the viscosity of the matrix phase. The first and second face sheets and the plurality of containment sheets are collectively configured to contain the matrix phase within the 3-D lattice structure.

Another aspect of the invention includes a method of making a three-dimensional (3-D) composite structure, including the steps of: forming, using additive manufacturing techniques a 3-D lattice structure that comprises a plurality of electrically insulative struts, forming a matrix phase surrounding the 3-D lattice structure, positioning first and second electrically conductive face sheets on two faces of the 3-D lattice structure, and positioning a plurality of electrically insulative containment sheets on all faces of the 3-D lattice structure that do not include the first and second face sheets. The matrix phase comprises an electrorheological material. The first and second face sheets are positioned such that an electric potential applied between the first and second face sheets creates an electric field in the matrix phase that causes a desired reversible alteration to the viscosity of the matrix phase. The first and second face sheets and the plurality of containment sheets are collectively configured to contain the matrix phase within the 3-D lattice structure.

### BRIEF DESCRIPTION OF THE DRAWINGS

FIG. 1 is an isometric view of the stellated octahedron reinforcing lattice cell with a matrix phase.

FIG. 2 is an isometric view of another stellated octahedron reinforcing lattice cell of with a matrix phase.

FIG. 3 is a isometric view of an exemplary composite material of this disclosure that includes electrically conductive face sheets and a matrix comprising an electrorheological material.

FIG. 4 is an isometric view of the stellated octahedron reinforcing lattice cell of FIG. 2 having a stain limiting structure and a matrix phase.

FIG. 5 is an isometric view of a pair of stellated octahedron reinforcing lattice cells having stain limiting structures and a matrix phase.

FIG. 6 is an isometric view of another pair of stellated octahedron reinforcing lattice cells having stain limiting structures and a matrix phase.

### DETAILED DESCRIPTION

Certain aerospace and other high performance applications require structures that can demonstrate a combination of light weight, high stiffness, strength, and toughness. In some applications, such structures can made from metallic or polymeric foam cores sandwiched between thin sheets of facing materials to form load bearing structures that may include aerodynamic surfaces. In other applications, the foam cores can be replaced by certain repeating three-dimensional (3-D) lattices structures, can be made from metallic or polymeric materials.

Another option for such structures is to use a core of repeating 3-D lattice structures filled with an electrorheological (ER) material surrounded by thin sheets of facing material to form reinforced sandwich materials. Such materials be used as load bearing structures and, if desired, may include aerodynamic surfaces. Surrounding or filling the repeating 3-D lattice structures, with a lower modulus, higher toughness ER material creates a composite material with the ER material as a matrix phase and the 3-D lattice structures as a reinforcing phase. Such a composite can be designed to have high strength and stiffness and to have a very high global Poisson's ratio≥1. When loaded in compression, contraction of the lattice elements around the tough matrix phase dissipates compressive forces and results in deformation with small strains. Such a composite will have high stiffness, high strength, and enhanced toughness.

The performance of composite materials made from a repeating 3-D lattice structure having a ER material matrix phase can be enhanced by embedding a strain limiting structure into the matrix phase at or near the center of each 3-D lattice structure. The strain limiting structure, which can have a higher strength than the ER material matrix phase, limits deformation of struts that make up the 3-D lattice structure, resulting in an overall higher ultimate strength for the composite material.

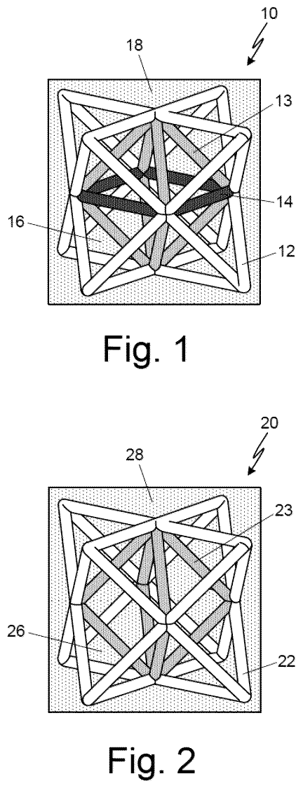

FIG. 1 show a 3-D lattice structure that can be the basis for the repeating 3-D lattice structure used as the reinforcing phase in the composite materials of this disclosure. The repeating 3-D lattice structure can be formed from any electrically insulative material deemed appropriate for a particular application. For example, the repeating 3-D lattice structure can be made from an electrically insulative polymeric material. FIG. 1 shows a 3-D lattice structure 10, in this case a stellated octahedron, formed with a plurality of struts 12, including two sets of stiffening struts 13, 14. As discussed above, the struts 12, 13, 14 can be made from suitable electrically insulative materials and can be formed with additive manufacturing (AM) techniques known in the art. For example, the AM techniques can include powder bed fusion processes (e.g., laser powder bed fusion, electron beam powder bed fusion, etc.), direct ink writing, fused deposition modeling, material jetting, stereolithography, and other processes. Depending on the materials selected for the components of the 3-D lattice structure 10, it may be desirable to use an AM technique that can deposit multiple materials in a single build campaign.

While the struts 12, 13, 14 are shown with constant diameter circular cross-sections, the cross-sections could also have any other suitable geometric shape (e.g., triangular, rectangular, pentangular, etc.) and may have varying cross-sectional dimensions. In some applications, the combination of materials used to make the struts 12, 13, 14 and the shape and cross-sectional dimensions of the struts 12, 13, 14 can be selected to result in components having mechanical properties, including but not limited to modulus and toughness, deemed appropriate for a particular application. The spaces between the struts 12, 13, 14 include open spaces 16 that are filled with a suitable ER material matrix phase 18 as described further below. In some examples, the ER material matrix phase 18 may have a lower modulus and higher toughness than the material used to make the struts 12, 13, 14. While the 3-D lattice structure 10 is shown as a stellated octahedron other 3-D geometric shapes formed with a lattice structure can be used as the reinforcing phase in the composite materials of this disclosure.

FIG. 2 shows a 3-D lattice structure 20 similar to that depicted in FIG. 1 with the reinforcing struts 14 removed. The resulting 3-D lattice structure 20 includes a plurality of struts 22 with a single set of stiffening struts 23. Removing the reinforcing struts 24 from the 3-D lattice structure 10 of FIG. 1 to form 3-D lattice structure 20 is an example of how the 3-D lattice structures of this disclosure can be “tuned” to absorb more energy. Similar to the 3-D lattice structure 10 of FIG. 1, the 3-D lattice structure 20 of FIG. 2 includes open spaces 26 that are filled with a suitable ER material matrix phase 28. While the 3-D lattice structure 20 is shown as a stellated octahedron other 3-D geometric shapes formed with a lattice structure can be used as the reinforcing phase in the composite materials of this disclosure.

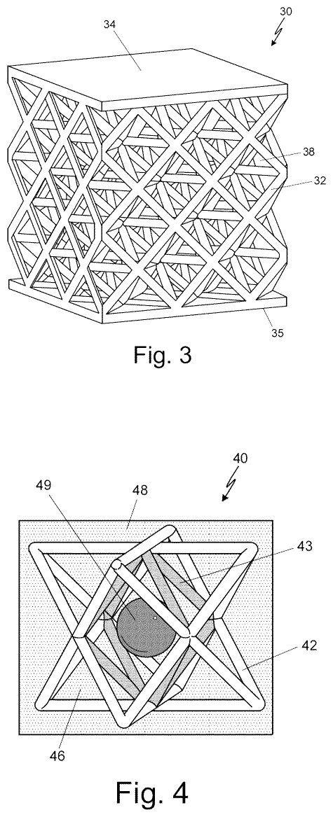

FIG. 3 is a isometric view of an exemplary reinforced structure 30 having a plurality of 3-D lattice structures 32 formed into a sandwich structure having a first face sheet 34 and a second face sheet 35 positioned on two faces of the 3-D lattice structure 32 and a plurality of electrically insulative containment sheets (not expressly shown to permit viewing of the 3-D lattice structure 32) positioned on the remaining faces of the 3-D lattice structure 32. In this view, the 3-D lattice structures 32 are shown as generic 3-D lattice structures to illustrate the variety of 3-D lattice structures that can be used to form such a structure. For example, the 3-D lattice structures 32 can be any of the 3-D lattice structures depicted in FIGS. 1-2. The reinforced structure 30 also include an ER matrix phase 38 as described with regard to FIGS. 1-2 filling the open spaces 36 in the reinforced structure 30. The first face sheet 34 and second face sheet 35 and the plurality of containment sheets are collectively configured to contain the ER matrix phase 38 within the 3-D lattice structure 30.

As discussed above, the matrix phase 38 comprises an ER material. ER materials can be suspensions of extremely fine, non-conducting but electrically active particles with primary dimensions (e.g., diameter or other longest dimension) ranging 5 nanometers up to 50 micrometers dispersed in an electrically insulating carrier fluid. The apparent viscosity of the ER materials is altered reversibly in response to an electric field applied to the matrix phase 38. The electrical field is generated by the electrical potential applied between the first face sheet 34 and second face sheet 35. When activated by the electric field, the ER material's yield point is determined by the electric field strength. After the yield point is reached, the ER material shears as a fluid (i.e., the incremental shear stress is proportional to the rate of shear). As a result, the ER material's viscosity can be controlled by adjusting the applied electric field. The fundamental properties of ER materials are based on particle size, density, base fluid properties, temperature and additives. A higher volume ratio of the dispersed particulates phase in the carrier fluid can offer the ER materials a considerably higher electrorheological effect. A person of ordinary skill will know how to select ER materials for the matrix phase 38 that are suitable for a particular application.

The first face sheet 34 and second face sheet 35 are electrically conductive materials positioned on two faces of the 3-D lattice structure and configured to generate an electrical field in the matrix phase 38 when an electric potential is applied between the face sheets 34, 35. The electrical field in the matrix phase 38 alters reversibly the apparent viscosity of the matrix phase's 38 ER materials. For example, the first face sheet 34 and second face sheet 35 can be made in whole or in part from metals, electrically conductive polymers or composites, or other electrically conductive materials as long as the first face sheet 34 and second face sheet 35 are capable of generating the desired electrical field.

The plurality of electrically insulative containment sheets and the struts 12, 22, 32 are built from electrically insulative materials to facilitate formation of the desired electrical field in the matrix phase 38 between the electrically conductive first face sheet 34 and second face sheet 35. The plurality of electrically insulative containment sheets and the struts 12, 22, 32 can, for example, be made from polymeric or composite materials that are electrical insulators.

FIG. 4. shows a 3-D lattice structure 40 similar to that depicted in FIG. 2 that includes a strain limiting structure 49 positioned an open space 46 at or near the center of the 3-D lattice structure 40 such that strain limiting structure 49 will be embedded in the matrix phase 38. The struts 42, 43 and the matrix 38 of FIG. 4 can be made from the same materials and have the same properties as discussed above with regard to the comparable elements of FIGS. 1, 2, and 3. The strain limiting structure 49 of FIG. 4 can have a higher strength (and in some examples, higher hardness) than the matrix 48 to limit further the deformation of the struts 42, 43 of the 3-D lattice structure 40. In some examples, the strain limiting structure 49 of the 3-D lattice structure 40 can be hollow or formed as a composite material, provided that the strain limiting structure 49 continues to have a higher strength (and in some examples, higher hardness) than the matrix 48. As a result, a compressive or tensile load applied to the 3-D lattice structure 40 of FIG. 4, will initially (and mostly) be absorbed/distributed by the Poisson effect created by deformation of the matrix phase 48. After some deformation of the lattice structure 40, the struts 42, 43 would contact the strain limiting structure 49 in the center of each 3-D lattice structure 40. The strain limiting structure 49 would provide much more resistance to deformation than the surrounding matrix phase 48. This construction will give the 3-D lattice structure 40 a much higher ultimate strength because the struts 42, 43 would be mostly intact and subjected to supported bending rather than buckling. In addition to including the strain limiting structure 49 in the center of each 3-D lattice structure 40, the struts 42, 43 can be designed to optimize the eventual interaction with it, i.e., the struts that would be subjected to compression could have an idealized shape for resistance to buckling while being bent around the solid object geometry. In some examples, the strain limiting structure 49 can be fixed to at least one of the plurality of struts 42, 43.

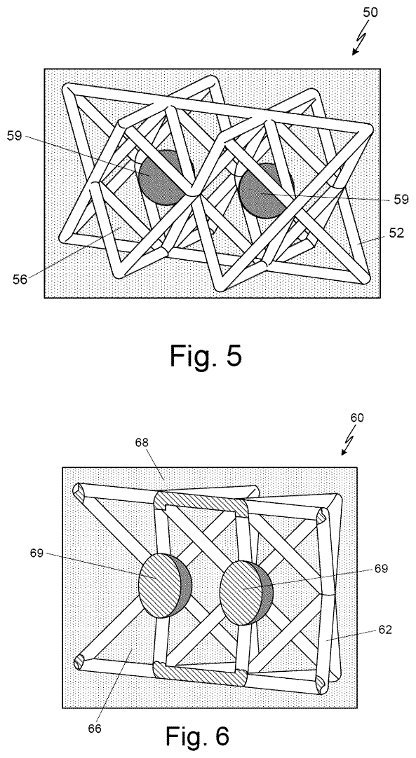

FIG. 5 shows a 3-D lattice structure 50 similar to that depicted in FIG. 4 that include two lattice structures. It should understood that a 3-D lattice structure like that shown in FIG. 5 can include any number of lattice structures as desirable for a particular application. Similar to the structures of FIG. 4, the 3-D lattice structure 50 includes a strain limiting structure 59 positioned an open space 56 at or near the center of the 3-D lattice structure 50 such that strain limiting structure 59 will be embedded in the matrix phase 58. In some examples, the strain limiting structure 59 can be fixed to at least one of the plurality of struts 52.

FIG. 6 shows a 3-D lattice structure 60 similar to that depicted in FIG. 5 that includes two lattice structures. As with the structure of FIG. 5, it should understood that a 3-D lattice structure like that shown in FIG. 6 can include any number of lattice structures as desirable for a particular application. Similar to the structure of FIG. 5, the 3-D lattice structure 60 includes a strain limiting structure 69 positioned an open space 66 at or near the center of the 3-D lattice structure 60 such that the strain limiting structure 69 will be embedded in the matrix phase 58. The primary difference between the structures of FIG. 6 and FIG. 5 is the shape of the strain limiting structure 69 compared to the strain limiting structure 59. These differences illustrate that the shape of any of the strain limiting structures 59, 59, 69 described in this disclosure can be any shape suitable for a particular application and are not limited to the spheres depicted in FIGS. 4 and 5 and the hemisphere depicted in FIG. 6. In some examples, the strain limiting structure 69 can be fixed to at least one of the plurality of struts 62.

For all of the examples discussed with regard to FIGS. 1 to 6, the desired strut 12, 22, 32, 42, 52, and 62 shapes can be made with suitable additive manufacturing (AM) techniques (i.e., 3-D printing). The strain limiting structures 49, 59, 69 can also be made with AM techniques and can designed to control the ultimate failure strength and mode of the 3-D lattice structures. Similarly, the electrically conductive face sheets 34, 35 and the electrically insulative containment sheets can, in some examples, also be made using AM techniques. As shown in FIGS. 4 to 6, the struts 42, 52, 62 can be formed as rods and the strain limiting structures 49, 59, 69 of can be formed as a sphere or hemisphere. In some examples, though, the struts 42, 52, 62 can be formed without a uniform cross section along their respective lengths and can be axis asymmetric. Likewise, the strain limiting structures 49, 59, 69 can be any shape, including non-symmetric shapes, having any desired orientation. In addition, the strain limiting structures 49, 59, 69 can, in some examples, be a composites themselves to permit enhanced energy absorption. In another example, the matrix phase 18, 28, 38, 48, 58, 68, electrically conductive face sheets, electrically insulative containment sheets, and/or strain limiting structures 49, 59, 69 can be made of fire retardant materials so the 3-D lattice structures of this disclosure can be used in fire resistant assemblies. Suitable fire retardant materials can include those deemed appropriate for a specific application, including but not limited to Tetrabromobisphenol A (TBBPA); Hexabromocyclododecane (HBCD); Ethane; 1,2-dibromo; Antimony oxide (Sb₂O₃); Triphenyl phosphate (TPP); Tricresyl phosphate (TCP).

For all of the examples discussed with regard to FIGS. 1 to 6, the material properties for each component can be selected to provide desired performance in conjunction with all of the other properties of a 3-D composite structure. For example, the properties of interest for the struts 12, 22, 32, 42, 52, and 62 can include: yield flexural/bending strength, ultimate flexural/bending strength, yield compressive strength, ultimate compressive strength, stiffness (Young's modulus), hardness, ductility (% elongation to failure), and toughness. The properties of interest for the matrix phase 18, 28, 38, 48, 58, and 68 can include: resilience, viscosity (fluid), yield compressive strength, and ultimate compressive strength. The properties of interest for the strain limiting structures 49, 59, 69 can include: hardness, compressive strength, and stiffness. The properties of interest for the overall 3-D composite structure can include: Poisson's ratio, yield flexural/bending strength, ultimate flexural/bending strength, yield compressive strength, ultimate compressive strength, stiffness (Young's modulus), and fatigue limit.

The 3-D lattice structures of this disclosure are constructed to have a desirable combination of energy-absorption, toughness, ultimate strength, and stiffness. Using a multi-material AM machine (e.g., a multi-material 3D printer), the material used to form each component of the 3-D lattice structures can be selected to provide a selected level of performance. This can enable many custom uses or designs with very little added cost. The material use to form each component of the 3-D lattice structures can be printed and filled quickly, thus speeding up validation of any mechanical property analysis. The size, shape, and material of construction for each of the components (struts, matrix phase, and strain limiting structures) can be selected to meet requirements of particular applications. As discussed above, the strut cross-section can be non-circular and/or variable to achieve desired performance characteristics. Similarly, the strain limiting structures can be any shape and/or formed from a composite material. For example, the strain limiting structures can be gas filled to provide compressible cushion effect. The 3-D lattice structures can be formed from any suitable polyhedron shape. Combining metallic struts with a matrix phase made from a ductile metal with low melting point can allow for a metallic 3-D lattice structure useful for higher temperature applications.

### Discussion of Possible Embodiments

The following are non-exclusive descriptions of possible embodiments of the present invention.

A three-dimensional (3-D) composite structure includes a 3-D lattice structure having a plurality of electrically insulative struts, a matrix phase surrounding the 3-D lattice structure, first and second electrically conductive face sheets positioned on two faces of the 3-D lattice structure, and a plurality of electrically insulative containment sheets positioned on all faces of the 3-D lattice structure that do not include the first and second face sheets. The matrix phase includes an electrorheological material. The first and second face sheets are positioned such that an electric potential applied between the first and second face sheets creates an electric field in the matrix phase that causes a desired reversible alteration to the viscosity of the matrix phase. The first and second face sheets and the plurality of containment sheets are collectively configured to contain the matrix phase within the 3-D lattice structure.

The 3-D composite structure of the preceding paragraph can optionally include, additionally and/or alternatively, any one or more of the following features, configurations and/or additional elements:

Further comprising a the strain limiting structure positioned at or near a center of the 3-D lattice structure and embedded within the matrix phase.

The 3-D lattice structure has a polyhedral shape.

The polyhedral shape is a stellated octahedron.

The matrix phase comprises a material having a lower modulus and higher toughness than a material used to form the plurality of struts.

The strain limiting structure comprises a material having a higher strength that a material used to form the matrix phase.

The strain limiting structure is fixed to at least one of the plurality of struts.

The plurality of struts and the matrix phase are formed from fire-retardant materials.

A method of making a three-dimensional (3-D) composite structure includes the steps of: forming, using additive manufacturing techniques a 3-D lattice structure that comprises a plurality of electrically insulative struts, forming a matrix phase surrounding the 3-D lattice structure, positioning first and second electrically conductive face sheets on two faces of the 3-D lattice structure, and positioning a plurality of electrically insulative containment sheets on all faces of the 3-D lattice structure that do not include the first and second face sheets. The matrix phase comprises an electrorheological material. The first and second face sheets are positioned such that an electric potential applied between the first and second face sheets creates an electric field in the matrix phase that causes a desired reversible alteration to the viscosity of the matrix phase. The first and second face sheets and the plurality of containment sheets are collectively configured to contain the matrix phase within the 3-D lattice structure.

The method of the preceding paragraph can optionally include, additionally and/or alternatively, any one or more of the following features, configurations and/or additional elements:

The method further comprising forming, using additive manufacturing techniques, a strain limiting structure positioned at or near a center of the 3-D lattice structure and fixed to at least one of the plurality of struts.

The 3-D lattice structure has a polyhedral shape.

The polyhedral shape is a stellated octahedron.

The matrix phase comprises a material having a lower modulus and higher toughness than a material used to form the plurality of struts.

The strain limiting structure comprises a material having a higher strength that a material used to form the matrix phase.

The strain limiting structure wherein the strain limiting structure is fixed to at least one of the plurality of struts.

The plurality of struts and the matrix phase are formed from fire-retardant materials.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A three-dimensional (3-D) composite structure, comprising:
a 3-D lattice structure that comprises a plurality of electrically insulative struts;
a matrix phase surrounding the 3-D lattice structure, wherein the matrix phase comprises an electrorheological material;
first and second electrically conductive face sheets positioned on two faces of the 3-D lattice structure, wherein the first and second face sheets are positioned such that an electric potential applied between the first and second face sheets creates an electric field in the matrix phase that causes a desired reversible alteration to the viscosity of the matrix phase; and
a plurality of electrically insulative containment sheets positioned on all faces of the 3-D lattice structure that do not include the first and second face sheets, wherein the first and second face sheets and the plurality of containment sheets are collectively configured to contain the matrix phase within the 3-D lattice structure.

2. The 3-D composite structure of claim 1, further comprising a the strain limiting structure positioned at or near a center of the 3-D lattice structure and embedded within the matrix phase.

3. The 3-D composite structure of claim 1, wherein the 3-D lattice structure has a polyhedral shape.

4. The 3-D composite structure of claim 3, wherein the polyhedral shape is a stellated octahedron.

5. The 3-D composite structure of claim 1, wherein the matrix phase comprises a material having a lower modulus and higher toughness than a material used to form the plurality of struts.

6. The 3-D composite structure of claim 1, wherein the strain limiting structure comprises a material having a higher strength that a material used to form the matrix phase.

7. The 3-D composite structure of claim 2, wherein the strain limiting structure is fixed to at least one of the plurality of struts.

8. The 3-D composite structure of claim 1, wherein the plurality of struts and the matrix phase are formed from fire-retardant materials.

9. A method of making a three-dimensional (3-D) composite structure, comprising the steps of:
forming, using additive manufacturing techniques, a 3-D lattice structure that comprises a plurality of electrically insulative struts;
forming a matrix phase surrounding the 3-D lattice structure, wherein the matrix phase comprises an electrorheological material;
positioning first and second electrically conductive face sheets on two faces of the 3-D lattice structure, wherein the first and second face sheets are positioned such that an electric potential applied between the first and second face sheets creates an electric field in the matrix phase that causes a desired reversible alteration to the viscosity of the matrix phase; and
positioning a plurality of electrically insulative containment sheets on all faces of the 3-D lattice structure that do not include the first and second face sheets, wherein the first and second face sheets and the plurality of containment sheets are collectively configured to contain the matrix phase within the 3-D lattice structure.

10. The method of claim 9, further comprising:
forming, using additive manufacturing techniques, a strain limiting structure positioned at or near a center of the 3-D lattice structure and fixed to at least one of the plurality of struts.

11. The method of making 3-D composite structure of claim 9, wherein the 3-D lattice structure has a polyhedral shape.

12. The method of making 3-D composite structure of claim 11, wherein the polyhedral shape is a stellated octahedron.

13. The method of making 3-D composite structure of claim 9, wherein the matrix phase comprises a material having a lower modulus and higher toughness than a material used to form the plurality of struts.

14. The method of making 3-D composite structure of claim 9, wherein the strain limiting structure comprises a material having a higher strength that a material used to form the matrix phase.

15. The method of making 3-D composite structure of claim 9, wherein the strain limiting structure wherein the strain limiting structure is fixed to at least one of the plurality of struts.

16. The method of making 3-D composite structure of claim 9, wherein the plurality of struts and the matrix phase are formed from fire-retardant materials.
